(19) United States
(12) Patent Application Publication
(10) Pub. No.: US 2004/0127253 A1
(43) Pub. Date: Jul. 1, 2004

(54) Method for displaying a presence status on a display unit of a mobile telephone

(76) Inventors: Andreas Hauptvogel, Berlin (DE); Michael Lemke, Berlin (DE)

Correspondence Address: MORRISON & FOERSTER LLP, 1650 TYSONS BOULEVARD, SUITE 300, MCLEAN, VA, 22102, US

(21) Appl. No.: 10/651,291

(22) Filed: Aug. 29, 2003

(30) Foreign Application Priority Data
Sep. 2, 2002 (DE) 102 41 096.8

(51) Int. Cl. H04Q 7/20

(52) U.S. Cl. 455/556.2; 455/457

(57) ABSTRACT

The invention relates to a method for displaying a presence status for a communications subscriber on a display unit (A) of a mobile telephone (M), in which the mobile telephone (M) receives presence data (PD) which describes the presence status, the presence data (PD) is associated with presence display data (PAD) which can be output by the display unit (A), and when telephone book data (K5) which is stored in a telephone book store (TS) in the mobile telephone (M) is checked (AB) together with the telephone book data (K5), the presence display data (PAD) is transmitted to the display unit (A) of the mobile telephone (M), and is displayed there.

This application claims priority to German application 10241096.8, which was filed in the German language on Sep. 2, 2002, the contents of which are hereby incorporated by reference.

The invention relates to a method for displaying a presence status for a communications subscriber on a display unit of a mobile telephone.

The document 3GPP TS 23.141 V0.0.0. “3rd Generation Partnership Project; Technical Specification Group Services and System Aspects; Presence Service; Architecture and Functional Description (Release 6)” dated June 2002 describes a service which is referred to as a “presence service” in which a presence computer (presence server) is used to monitor characteristics of selected communications subscribers. These characteristics—which are referred to as a presence status—include, for example, the respective current accessibility via telephone, written short messages (SMS) or e-mail. In order to indicate the communications subscribers via which a specific user wishes to receive information about such presence characteristics, the respective user sends a monitoring list (watcher list) to the presence computer. This monitoring list contains an enumeration of the people who are of interest to the user and are to be monitored, and their communications terminals.

Depending on the content of this watcher list, the presence computer sends presence data to a communications terminal (for example a mobile telephone) of the user about the appliances or people to be monitored.

The invention is based on the object of specifying a method which allows the presence status to be output on a display unit of the mobile telephone.

According to the invention, this object is achieved by a method for displaying a presence status for a communications subscriber on a display unit of a mobile telephone, in which the mobile telephone receives presence data which describes the presence status, the presence data is associated with presence display data which can be output by the display unit, and when telephone book data which is stored in a telephone book store in the mobile telephone is checked together with the telephone book data, the presence display data is also transmitted to the display unit of the mobile telephone, and is displayed there as required. In this case, it is particularly advantageous for the presence display data to be displayed on the display unit of the mobile telephone when a check of the telephone book data has been carried out, that is to say when information which is relevant to the communications subscriber is required. The presence display data is thus advantageously not displayed in an isolated form on its own, but in conjunction with other data, which is stored in the telephone book of the mobile telephone, about the same communications subscriber (to be monitored).

The method according to the invention can be implemented in such a way that the presence display data is output together with the telephone book data on the display unit.

One refinement of the method according to the invention provides that the mobile telephone receives the presence data from a presence computer which is connected to the mobile telephone via a mobile radio network.

The method according to the invention can be carried out in such a way that, after receiving the presence data from an image data store of the mobile telephone, image data which is associated with the presence data is read, this image data is transmitted as presence display data to the display unit of the mobile telephone, in response to which the presence status is output in the form of an image on the display unit. Displaying the presence status for the object to be monitored in image form makes it possible for a user of the method to receive the presence information very quickly, to a certain extent “at a glance”. It is furthermore also possible to display a relatively large number of presence information items on the (generally small) display area of the display unit of the mobile telephone in a clear manner. This type of display also allows information to be displayed independently of the language and in a manner which is comprehensible in different countries.

The method according to the invention can also be carried out in such a way that, after receiving the presence data from a text data store of the mobile telephone, text data which is associated with the presence data is read, this text data is transmitted as presence display data to the display unit of the mobile telephone, in response to which the presence status is output in the form of an alphanumeric character string on the display unit. This refinement of the method according to the invention can advantageously be used even with those mobile telephones whose display units are suitable only for outputting alphanumeric characters. This may be the case, for example, for relatively old mobile telephones. Furthermore, alphanumeric characters can be used to output additional information on the display unit which, for example, is supplementary to the information which is conveyed by outputting the image according to the embodiment described above.

In the method according to the invention, a SIM card which is connected to the mobile telephone or a preselected area of a RAM store of the mobile telephone can be used as the telephone book store.

In order to explain the invention further,

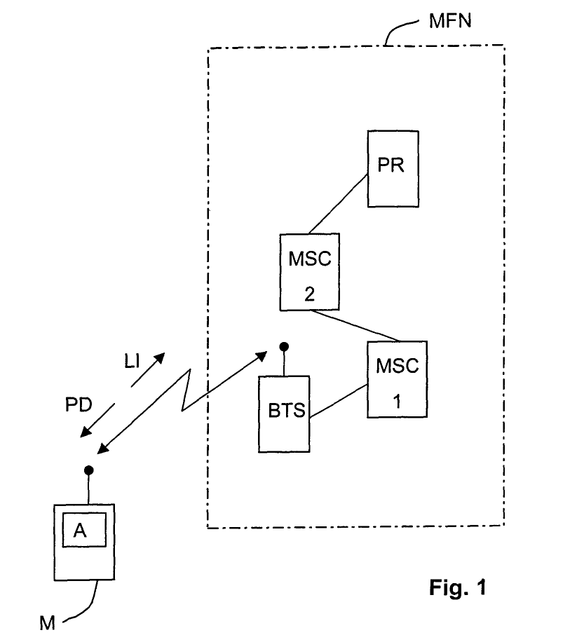

FIG. 1 shows a schematic illustration of one exemplary embodiment of a mobile radio network which is connected to a mobile telephone, and

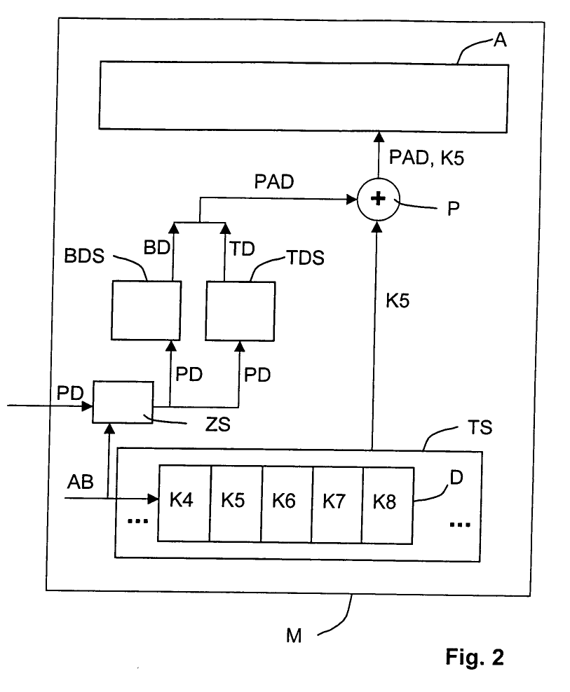

FIG. 2 shows a detailed exemplary embodiment of the method according to the invention.

FIG. 1 shows, schematically, a mobile telephone M with a display unit A which is connected to a mobile radio network MFN via an air interface. The air interface connects the mobile telephone M to a base station BTS (BTS=Base Transceiver Station), which is connected via a first mobile switching center MSC1 (MSC=Mobile Services Switching Center) and a second mobile switching center MSC2 to a presence computer PR (PR=Presence Server). In this case, the presence computer PR may also be located in another mobile radio network (not shown in FIG. 1), provided that this further mobile radio network is connected to the mobile radio network MFN which is illustrated in FIG. 1.

The mobile telephone M produces a monitoring list LI and transmits this to the presence computer PR via the air interface, the base station BTS and the mobile switching centers MSC1 and MSC2. The monitoring list contains information about those communications subscribers (that is to say, for example, the communications devices of mobile radio subscribers, landline network subscribers and Internet subscribers) whose presence status is intended to be monitored and displayed by means of the mobile telephone.

Depending on the content of this monitoring list, information about the subscriber devices to be monitored is transmitted by the presence computer PR in the form of presence data PD via the mobile switching centers MSC1 and MSC2 and the base station BTS in the mobile radio network MFN to the mobile telephone M. The method for displaying the presence status for these devices and/or for the users of these devices on the display unit on the mobile telephone will be described in detail with reference to FIG. 2.

FIG. 2 shows the procedures which take place within the mobile telephone M in order to display the presence status on the display unit A on the mobile telephone. In a first step, the presence data PD which describes the presence status is received by the mobile telephone M by means of a receiving device (which is not illustrated), and is passed to a buffer store ZS. The buffer store ZS stores the presence data until it is used further. If telephone book data from a telephone book store TS in the mobile telephone M is checked by means of a checking signal AB, then this checking signal AB is also passed to the buffer store ZS. Telephone book stores BS such as these in mobile telephones are occasionally also referred to as address book stores; this is the case in particular when they also contain further details such as addresses or personal notes in addition to the name and the telephone number of the communications subscriber.

The buffer store ZS and/or its control logic determine whether the buffer store contains presence data for the objects (for example a fax machine) or people (for example a mobile telephone subscriber) for which or whom telephone book data has been requested from the telephone book store by means of the checking signal AB. If no presence data is available for these people or objects, then the method for displaying the presence status is ended at this point, and only the method provided in the mobile telephone for displaying the checked telephone book data is carried out in the mobile telephone. However, if the buffer store ZS does contain such presence data, then this presence data is output from the buffer store and is passed to an image data store BDS and to a text data store TDS.

Image data BD associated with the presence data is output from the image data store BDS. This image data BD includes, for example, image information in the form of small-format images (icons) which are able to display the information content of the presence data in a clear manner. If, for example, the presence data includes the information that a communication partner to be monitored (who is also referred to as a presentity) can currently be accessed via his mobile telephone (because he has switched his mobile telephone on and is not already involved in a mobile telephone call), then this information can be displayed by means of an image on a mobile telephone. If the presence data contains the information that the communications subscriber of interest can currently be accessed via a landline telephone, then this can be presented by the image of a telephone handset.

If the presented communications subscriber is currently using a communications terminal (mobile telephone, laptop, palmtop, computer with Internet browser etc.) to play an online game with other game partners, and it is thus possible to make a connection to the communications subscriber by participating in this online game, then this presence data information can be displayed by means of an image which is characteristic of the appropriate game—for example by an image of a ship for a strategy game which involves the organization of cargo transportation by means of cargo ships. In an analogous manner, the current accessibility by e-mail can be displayed by displaying an image of a letter envelope, a current location in London can be displayed by an image of Tower Bridge, or current participation in a conference (during which the subscriber to be monitored does not wish to be disturbed) can be displayed in the form of an image by a symbolic display of a conference scene. The image data BD describing such images is transmitted as presence display data to a summation point P.

In parallel with the procedures in the image data store BDS as described above, the presence data PD which is output from the buffer store ZS is also transmitted to a text data store TDS. Text character strings (for example alphanumeric text strings) which correspond to the presence data are read from this text data store and are output as text data TD. This text data TD is also transmitted as presence display data to the information point P. If, for example, the presence data PD contains the information that the presentity subscriber can currently be accessed via his mobile telephone in Munich, then a text string “Munich” (or else a text string “Bavaria” which does not indicate the city name of the current location but only the associated State within Germany) which is associated with this location information can be output as text data and can be transmitted as presence display data to the summation point P. This text data may, for example, be used to supplement the image data which is read from the image data store BDS (in this case to supplement the image with the mobile telephone); later on, the image “mobile telephone” will be output together with the text string “Munich” on the display unit A on the mobile telephone. The use of the text data TD advantageously also makes it possible to display detailed information on the display unit which can be displayed only with difficulty by means of an image, or the display of which may lead to misunderstandings.

The checking signal AB is likewise transmitted to a telephone book store TS in the mobile telephone M. This telephone book store TS is used to store telephone book data D, from which telephone book data records K4, K5, K6, K7 and K8 are displayed in this exemplary embodiment. In the illustrated exemplary embodiment, the telephone book data K5 is checked as a result of the check AB of the stored telephone book data K4, K5, K6, K7 and K8; in consequence, the telephone book data K5 is output from the telephone book store TS, and is transmitted to the summation point P.

In the illustration shown in FIG. 2, the summation point P symbolizes a drive device, which is known per se, for the display A of the mobile telephone. This drive circuit P receives the respectively current telephone book data K5 and the presence display data PAD in the form of image data BD and text data TD. The presence display data PAD and the telephone book data K5 are transmitted to the display A on the mobile telephone, and are output on this display A (possibly after being processed by the drive circuit P). In this case, the presence display data PAD and the telephone book data K5 can be displayed jointly and simultaneously in a single view on the display A, which leads to a compact information display. However, it is just as possible, for example, to display the telephone book data K5 first of all in a first display output on the display unit A (possibly together with a note that this is presence display data). After this, once a preset time interval has passed or in response to an input signal (for example the push of a button), the presence display data PAD is then displayed automatically in a second display output on the display unit A. The decision as to whether the presence display data PAD and the telephone book data K5 are displayed together and simultaneously in a single view on the display A or successively in a number of views on the display unit A may, for example, be made on the basis of presets which are specific to that communications subscriber (and which can be stored together with the telephone book data in the telephone book store in the mobile telephone).

It is particularly advantageous for the presence display data to be output on the display A at the same time that the telephone book data KS is being output there. This is because it makes it possible for a user of the mobile telephone to at the same time have displayed to him or her, together with the information (which is in general static, that is to say it does not change with time) from the telephone book in the mobile telephone, the presence information which varies with time relating to the communications terminal of interest in each case, or relating to the communications subscriber of interest in each case. This type of display makes it possible for a mobile telephone user to identify, for example, when checking data relating to a communications subscriber from the telephone store in the mobile telephone that the communications subscriber to be monitored currently cannot be accessed via his mobile telephone (for example because it is switched off or the radio coverage is inadequate). At the same time, he receives information that this subscriber can, however, be accessed by e-mail via his laptop computer. When the user of the mobile telephone wishes to communicate, he can subsequently use the mobile telephone (for example automatically) to select the currently suitable communication medium, and the mobile radio network is not unnecessarily loaded with communication attempts which are unsuitable at that time.

A further advantage for the user of the mobile telephone is that the telephone book entries KS and the presence information can be displayed to him or her simultaneously on the display without he or she needing to carry out a number of control actions for this purpose. The described method is thus not only particularly user-friendly, but also avoids premature wear to the control elements on the mobile telephone (for example to the keys) by making a number of inputs for each desired display.

1. A method for displaying a presence status for a communications subscriber on a display unit (A) of a mobile telephone (M), in which
the mobile telephone (M) receives presence data (PD) which describes the presence status,
the presence data (PD) is associated with presence display data (PAD) which can be output by the display unit (A), and
when telephone book data (K5) which is stored in a telephone book store (TS) in the mobile telephone (M) is checked (AB) with the telephone book data (K5), the presence display data (PAD) is also transmitted to the display unit (A) of the mobile telephone (M), and is displayed there.

2. The method as claimed in claim 1,
characterized in that
the presence display data (PAD) is output together with the telephone book data (K5) on the display unit (A).

3. The method as claimed in claim 1,
characterized in that
the mobile telephone (M) receives the presence data (PD) from a presence computer (PR) which is connected to the mobile telephone (M) via a mobile radio network (MFN).

4. The method as claimed in claim 1,
characterized in that
after receiving the presence data (PD) from an image data store (BDS) of the mobile telephone (M), image data (BD) which is associated with the presence data (PD) is read,
this image data (BD) is transmitted as presence display data (PAD) to the display unit (A) of the mobile telephone (M),
in response to which the presence status is output in the form of an image on the display unit (A).

5. The method as claimed in claim 1,
characterized in that
after receiving the presence data (PD) from a text data store (TDS) of the mobile telephone (M), text data (TD) which is associated with the presence data (PD) is read,
this text data (TD) is transmitted as presence display data (PAD) to the display unit (A) of the mobile telephone (M),
in response to which the presence status is output in the form of an alphanumeric character string on the display unit (A).

6. The method as claimed in claim 1,
characterized in that
a SIM card which is connected to the mobile telephone is used as the telephone book store (TS).

7. The method as claimed in claim 1,
characterized in that
a preselected area of a RAM store of the mobile telephone is used as the telephone book store (TS).
